(19) United States
(12) Patent Application Publication
(10) Pub. No.: US 2015/0093701 A1
(43) Pub. Date: Apr. 2, 2015

(54) METHOD FOR CREATING A TRANSPARENCY HAVING WHITE TONER

(71) Applicants: DINESH TYAGI, Fairport, NY (US); Kevin D. Lofftus, Fairport, NY (US); Louise Granica, Victor, NY (US)

(72) Inventors: DINESH TYAGI, Fairport, NY (US); Kevin D. Lofftus, Fairport, NY (US); Louise Granica, Victor, NY (US)

(21) Appl. No.: 14/038,817

(22) Filed: Sep. 27, 2013

(51) Int. Cl. G03G 13/20; G03G 15/20; G03G 15/01

(52) U.S. Cl. CPC G03G 13/20
USPC 430/117.5; 399/223; 399/329

(57) ABSTRACT

A method for creating a document, the method includes the steps of providing a transparent substrate; providing a toner image, which includes a plurality of color toners and a black toner; determining an amount of white toner to be deposited dependent upon a mass laydown of the black toner and a covering power of the black toner; depositing the determined amount of white toner with the color toners and black toner on the transparent substrate; and fixing the deposited toners on the substrate.

### CROSS REFERENCE TO RELATED APPLICATIONS

Reference is made to commonly-assigned, co-pending U.S. patent application Ser. No. ______ (Kodak Docket K001624US01) filed concurrently herewith, entitled “A Transparency Document Having White Toner” by Tyagi, et al., the disclosure of which is incorporated herein.

### FIELD OF THE INVENTION

The present invention generally relates to transparencies and more particularly to transparencies having white toner applied as background for color and black toner in a manner in which the white toner is selectively used in various proportions in certain regions of the document and not used in certain portions of the document for efficient use of the white toner.

### BACKGROUND OF THE INVENTION

US Patent Publication 2007/0188535A1 discloses images having ordinary CMYK (cyan, magenta, yellow and black) and other colors on a clear or translucent substrate, but since the printed image should be viewed from both sides, there is a need for a white ink that can be used as a “process color” to achieve a wider range of images and viewability from both sides of the laminate. The substrate can be viewed from both of the sides of the image, without respect to the direction of the lighting. It replaces the need for a solid white layer behind the image by printing the white ink and the colored inks substantially at the same time. As a process color, the white ink is printed essentially simultaneously (substantially at the same time) with the other process colors. The ink jet printer controls the white ink and prints it as if it were a process color like the normal ink jet colors cyan, magenta, yellow and black.

Although satisfactory, this produces drawbacks such as the color gamut being reduced because of the white (loss of color density). In addition, color properties are also affected with white, presumably because inks are flowing into each other. It is also limited to inkjet printing which is not useable in electro-photographic printing. Finally, it does not teach how to limit the use of the white so as to reduce cost.

### SUMMARY OF THE INVENTION

The present invention is directed to overcoming one or more of the problems set forth above. Briefly summarized, according to one aspect of the invention, the invention resides in a method for creating a document, the method comprising the steps of: providing a transparent substrate; providing a toner image, which is comprised of a plurality of color toners and a black toner; determining an amount of white toner to be deposited dependent upon a mass laydown of the black toner and a covering power of the black toner; depositing the determined amount of white toner with the color toners and black toner on the transparent substrate; and fixing the deposited toners on the substrate.

These and other objects, features, and advantages of the present invention will become apparent to those skilled in the art upon a reading of the following detailed description when taken in conjunction with the drawings wherein there is shown and described an illustrative embodiment of the invention.

### Advantageous Effect of the Invention

The present invention has the advantage of depositing white toner only in selected areas of a document for cost savings. The same methodology can be used for other digital printing processes that are based on subtractive primary colors such as, but not limited to, inkjet, thermal printing and the like.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic side elevational view, in cross section, of a typical electrophotographic reproduction apparatus (printer) suitable for use in the practice of the present invention;

FIG. 2 is a side view in cross section illustrating a substrate having toner deposited thereon according to one embodiment of the present invention;

FIG. 3 is a side view in cross section illustrating a substrate having toner deposited thereon according to a second embodiment of the present invention;

FIG. 4 is a side view in cross section illustrating the embodiments of FIGS. 2 and 3 deposited and fixed arranged in an alternate embodiment on the substrate;

FIG. 5 is a side view in cross section illustrating the embodiments of FIGS. 2 and 3 deposited and fixed arranged in a second alternate embodiment on the substrate;

FIG. 6 is a side view in cross section illustrating the embodiments of FIGS. 2 and 3 deposited and fixed arranged in a third alternate embodiments on the substrate;

FIG. 7 is a graph illustrating the mass laydown of white toner relative to the mass laydown of various pigments of black toner.

### DETAILED DESCRIPTION OF THE INVENTION

Before describing the present invention, it is useful to understand its practical benefits as will be more apparent from the detailed description below. The present invention uses a transparent substrate onto which a toner image is fixed. The toner image includes color toner (typically C, M, Y), black toner and white toner. The present invention varies the amount of white toner to reduce cost and, in fact, in some regions, white toner is not even needed. It is important to note that the document is aesthetically pleasing and easily viewable despite the reduction of white toner.

As used herein, “toner particles” are particles of one or more material(s) that are transferred by an electrophotographic (EP) printer to a receiver to produce a desired effect or structure (e.g., a print image, texture, pattern, or coating) on the receiver. Toner particles can be ground from larger solids, or chemically prepared (e.g., precipitated from a solution of a pigment and a dispersant using an organic solvent), as is known in the art. Toner particles can have a range of diameters (e.g., less than 8 μm, on the order of 10-15 μm, up to approximately 30 μm, or larger), where “diameter” preferably refers to the volume-weighted median diameter, as determined by a device such as a Coulter Multisizer.

“Toner” refers to a material or mixture that contains toner particles and that can be used to form an image, pattern, or coating when deposited on an imaging member including a photoreceptor, a photoconductor, or an electrostatically charged or magnetic surface. Toner can be transferred from the imaging member to a receiver. Toner is also referred to in the art as marking particles, dry ink, or developer, but note that herein “developer” is used differently, as described below. Toner can be a dry mixture of particles or a suspension of particles in a liquid toner base.

As mentioned already, toner includes toner particles; it can also include other types of particles. The particles in toner can be of various types and have various properties. Such properties can include absorption of incident electromagnetic radiation (e.g., particles containing colorants such as dyes or pigments), absorption of moisture or gasses (e.g., desiccants or getters), suppression of bacterial growth (e.g., biocides, particularly useful in liquid-toner systems), adhesion to the receiver (e.g., binders), electrical conductivity or low magnetic reluctance (e.g., metal particles), electrical resistivity, texture, gloss, magnetic remanence, florescence, resistance to etchants, and other properties of additives known in the art.

The term “covering power” (CP) refers to the coloring strength (optical density) value of fixed toner particles on a specific receiver material. For example, covering power values can be determined by making patches of varying densities from fixed dry toner particles on a receiver material such as a clear film. The weight and area of each of these patches is measured, and the dry toner particles in each patch are fixed, for example, in an oven with controlled temperature that is hot enough to melt the dry toner particles sufficiently to form a continuous thin film in each patch on the receiver material. The transmission densities of the resulting patches of thin films are measured with a Status A blue filter on an X-rite densitometer (other conventional densitometers can be used). A plot of the patch transmission densities vs. initial patch dry toner weight is prepared, and the weight per unit area of toner thin film is calculated at a transmission density of 1.0. The reciprocal of this value, in units of cm²/g of toner particles, is the “covering power”. Another way of saying this is that the covering power is the area of the receiver material that is covered to a transmission density of 1.0 by 1 gram of dry toner particles. As the covering power increases, the “yield” of the dry toner particles increases, meaning that less mass of dry toner particles is needed to create the same amount of density area coverage in a printed image on the receiver material. Thus, covering power is a measurement that is taken after the dry toner particles are fixed (or fused) to a given receiver material. A skilled worker would be able from this description to measure the covering power of any particular dry toner particle composition (containing polymer binder, colorants, and optional addenda), receiver material, and fixing conditions.

In single-component or mono-component development systems, “developer” refers to toner alone. In these systems, none, some, or all of the particles in the toner can themselves be magnetic. However, developer in a mono-component system does not include magnetic carrier particles. In dual-component, two-component, or multi-component development systems, “developer” refers to a mixture including toner particles and magnetic carrier particles, which can be electrically-conductive or -non-conductive. Toner particles can be magnetic or non-magnetic. The carrier particles can be larger than the toner particles (e.g., 15-300 μm in diameter). A magnetic field is used to move the developer in these systems by exerting a force on the magnetic carrier particles. The developer is moved into proximity with an imaging member or transfer member by the magnetic field, and the toner or toner particles in the developer are transferred from the developer to the member by an electric field, as will be described further below. The magnetic carrier particles are not intentionally deposited on the member by action of the electric field; only the toner is intentionally deposited. However, magnetic carrier particles, and other particles in the toner or developer, can be unintentionally transferred to an imaging member. Developer can include other additives known in the art, such as those listed above for toner. Toner and carrier particles can be substantially spherical or non-spherical.

The electrophotographic process can be embodied in devices including printers, copiers, scanners, and facsimiles, and analog or digital devices, all of which are referred to herein as “printers.” Various embodiments described herein are useful with electrostatographic printers such as electrophotographic printers that employ toner developed on an electrophotographic receiver, and ionographic printers and copiers that do not rely upon an electrophotographic receiver. Electrophotography and ionography are types of electrostatography (printing using electrostatic fields), which is a subset of electrography (printing using electric fields). The present invention can be practiced using any type of electrographic printing system, including electrophotographic and ionographic printers.

The printer can also include a color management system that accounts for characteristics of the image printing process implemented in the print engine (e.g., the electrophotographic process) to provide known, consistent color reproduction characteristics. The color management system can also provide known color reproduction for different inputs (e.g., digital camera images or film images). Color management systems are well-known in the art, and any such system can be used to provide color corrections in accordance with the present invention.

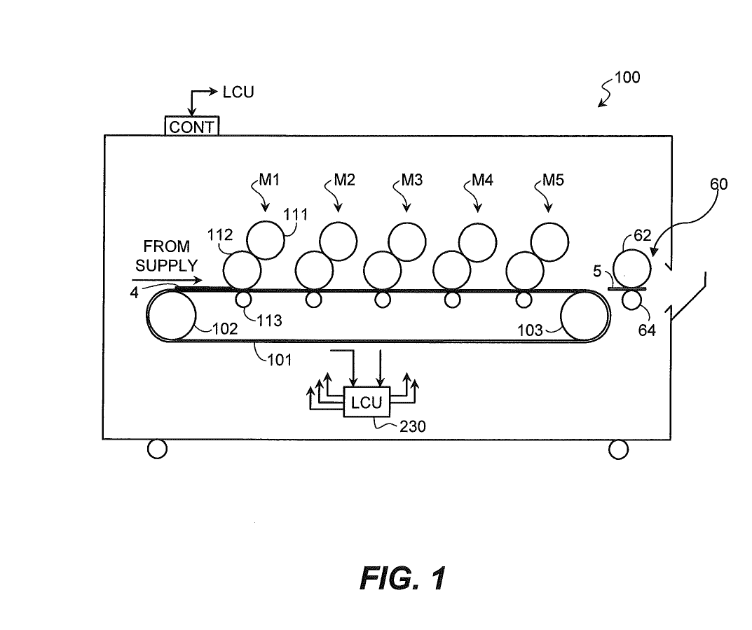

Turning now to FIG. 1, a useful printing machine of the present invention is illustrated. FIG. 1 is a side elevational view schematically showing portions of a typical electrophotographic print engine or printer apparatus suitable for printing one or more toner images. An electrophotographic printing apparatus 100 has a number of sequentially arranged electrophotographic image forming printing modules M1, M2, M3, M4, and M5. Each of the printing modules M1-M5 generates a single dry toner image for transfer to a receiver material successively moved through the modules M1-M5. Each receiver material, during a single pass through the five modules M1-M5, can have transferred in registration thereto up to five single toner images. A composite color toner image formed on a receiver material can comprise combinations or subsets of CMY color toner images, black toner images and white toner images on the receiver material. In a particular embodiment, printing module M1 forms white (W) toner color separation images, M2 forms cyan (C) toner color separation images, M3 forms magenta (M) toner color separation images, M4 forms yellow (Y) toner color separation images, and module M5 forms a black (K) toner image. Alternatively, the white (W) toner image may be positioned in either module M2 or M5 in which case the color in that particular module is switched to the M1 module.

A transparent substrate 4, such as transparent receiver materials, as shown in FIG. 1, are delivered from a transparency supply unit (not shown) and transported through the printing modules M1-M5. The transparency substrate 4 is adhered [for example electrostatically using coupled corona tack-down chargers (not shown)] to an endless transport web entrained and driven about rollers 102 and 103.

Each of the printing modules M1-M5 includes a photoconductive imaging roller 111, an intermediate transfer roller 112, and a transfer backup roller 113, as is known in the art. For example, at printing module M1, a particular toner separation image can be created on the photoconductive imaging roller 111, transferred to intermediate transfer roller 112, and transferred again to the transparent substrate 4 moving through a transfer station, which transfer station includes intermediate transfer roller 112 forming a pressure nip with a corresponding transfer backup roller 113.

The transparent substrate 4 can sequentially pass through the printing modules M1 through M5. In some or all of the printing modules M1-M5 a toner separation image can be formed on the receiver material 5 to provide the desired document comprising cyan, magenta, yellow and black (CMYK) and white (W). Electro-photographic printing apparatus 100 has a fuser of any well known construction, such as the shown fuser assembly 60 using fuser rollers 62 and 64 or nip-rollers at least one of which is heated. The transparent substrate 4 of the present invention is preferably fused during one pass through the nip-rollers by heat and pressure which is advantageous from a cost and time perspective.

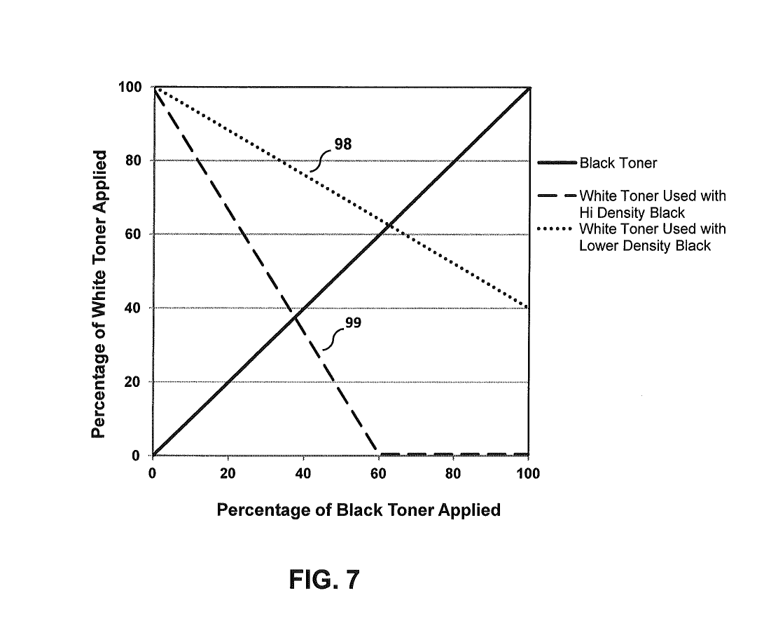

A logic and control unit (LCU) 230 can include one or more processors and in response to signals from various sensors (CONT) associated with the electrophotographic printer apparatus 100 provides timing and control signals to the respective components to provide control of the various components and process control parameters of the apparatus as known in the art. In the present invention, the LCU 230 includes a look-up table that is used to determine a varying amount of the white toner deposited on the transparent substrate 4. More specifically, the logic and control unit 230 varies the amount of white toner dependent upon a mass laydown of the black toner and a covering power of the black toner. Referring briefly to FIG. 7, there is a graph illustrating the amount of laydown of white toner relative to the black toner.

When a black toner with high covering power is used in the printer, the white does not need to be placed behind the black toner when sufficient black toner is present to provide the adequate opacity to the substrate. At lower mass laydown of this high-density black, some white toner would be necessary to impart opacity. The amount of white that will be needed increases as the amount of black toner used is decreased as shown in FIG. 7, curve 99. However, when the covering power of the black toner is not sufficiently high enough to give the desired opacity even at the highest mass laydown of the black toner, some white toner would still be needed to provide the opacity to the transparent or clear substrate. As before, the amount of white toner would increase as the mass laydown of the low density black toner is decreased as shown in FIG. 7, curve 98. The covering power threshold where the black toner would not require the use of white at high black mass laydown is determined by the expression:

Covering Power (CP) of Black Toner>130000/Dᵥₒₗ

where Dᵥₒₗ is the median volume average diameter of the black toner

Although not shown, the electrophotographic printing apparatus 100 can have a duplex path to allow feeding a receiver material having a fused toner image thereon back to printing modules M1 through M5. When such a duplex path is provided, two sided printing on the receiver material or multiple printing on the same side is possible.

Operation of the electro-photographic printing apparatus 100 will be described. Image data for writing by the electrophotographic printing apparatus 100 are received and can be processed by a raster image processor (RIP), which can include a color separation screen generator or generators. The image data include information to be formed on the receiver material, which information is also processed by the raster image processor. The output of the RIP can be stored in frame or line buffers for transmission of the color separation print data to each of the respective printing modules M1 through M5 for printing color separations in the desired order. The RIP or color separation screen generator can be a part of the printer apparatus or remote therefrom. Image data processed by the RIP can at least partially include data from a color document scanner, a digital camera, a computer, a memory or network. The image data typically include image data representing a continuous image that needs to be reprocessed into halftone image data in order to be adequately represented by the printer.

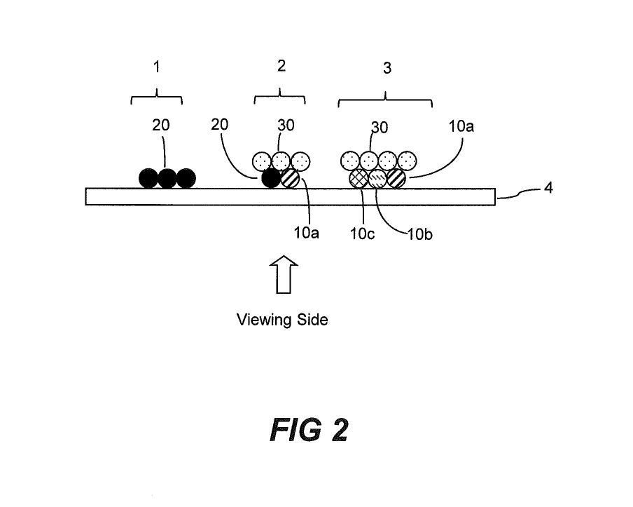

Referring to FIG. 2, there is shown a side view of the transparent substrate 4 having a plurality of color toners 10a, 10b and 10c (collectively referred to as numeral 10 hereafter) and black toner 20 and a varying amount of white toner 30. The transparent substrate 4 is preferably any transparent medium receptive to toner printing. The transparent substrate 4 includes a viewing side as indicated by the arrow for indicating which side and direction a person preferably views the transparent substrate 4. In the embodiment of FIG. 2, the black toner 20 is of a high density which means that the pigments concentration is such that it has a covering power (CP) that meets the following criteria:

CP of Black Toner>130000/Dᵥₒₗ

where Dᵥₒₗ is the median volume average diameter of the black toner.

The plurality of color toners 10 and black toner 20 in any desired combination form a toner image (the particular image desired to be viewed). It is noted that the black toner 20 and every color toner 10 may not be necessary at each location on the transparent substrate 4. The white toner provides a background so that the toner image can be easily viewed. The look-up table of the logic and control unit 230 (FIG. 1) uses the curve for high density black to determine the amount of white toner 30 to be deposited by the electrophotographic printing apparatus 100 (FIG. 1). The white toner 30, color toner 10 and black toner 20 are then fused or fixed to the transparent substrate 4 by the electrophotographic printing apparatus 100 for forming a fused image.

FIG. 2 illustrates different combinations of color toner 10 and black toner 20 needed for a particular location for a toner image and the respective amount of white toner 30 needed for that particular location based on the amount of black toner 20 in that particular color combination. For example, at region 1 of the transparent substrate 4, there is only black toner 20 needed for the toner image, and white toner 30 is not necessary to provide an aesthetically pleasing toner image. The amount of white toner 30 was determined from the look-up table of the logic and control unit 230 based on the mass laydown of the black toner 20 and covering power of the black toner 20. Consequently, the cost of supplying white toner 30 is saved. At region 2, there is a toner image formed from black toner 20 and one color toner 10a (cyan for example) and the amount of white toner 30 necessary for an aesthetically pleasing image as determined by the look-up table based on the mass laydown of the black toner 20 and covering power of the black toner 20. At region 3, there are three color toners 10 (CMY) without any black toner 20 at a location of the toner image. In this case, a different amount of white toner 30 is determined by the look-up table which is then deposited by the electrophotographic printing apparatus 100. In each case, the white toner 30, if needed, is deposited on top of the color toner 10 and black toner 20. It is important to note that, by varying the amount of white toner 30 based on the mass laydown and covering power of the black toner 20, cost savings occur because of the reduced amount of white toner 30 necessary for the toner image as compared to the prior art. In other words, the white toner 30 is non-uniform in mass laydown as determined by a covering power of the fused black toner 20. Given the known covering power of black toner 20, the logic and control unit 230 uses the particular curve 98 or 99 for this covering power to determine the amount of white toner 30 to be deposited. The embodiment of FIGS. 2 to 6 illustrate some combinations of the color, black and white toners; however, those skilled in the art will readily recognize that other combinations of the color, black and white toners are possible depending on the color requirements of the image.

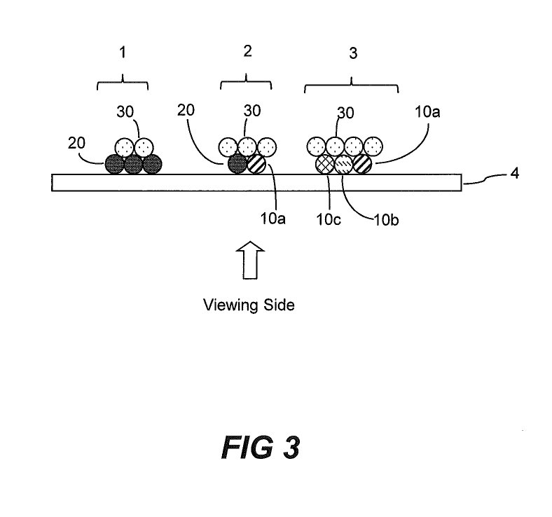

FIG. 3 illustrates a second embodiment in which low density black toner 20 is used. In this case, the look-up table of the logic and control unit 230 (FIG. 1) uses the low density curve 98 (FIG. 7) to determine the amount of white toner 30. Low density black toner is defined as the black toner 20 which has a covering power defined by the expression:

CP of Black Toner<130000/Dᵥₒₗ

where Dᵥₒₗ is the median volume average diameter of the black toner.

At region 1 of the transparent substrate 4, there is black toner 20 and white toner 30 needed for the toner image, and white toner 30 is deposited in a smaller amount as compared to regions 2 and 3. At region 2, there is a toner image formed from black toner 20 and one color toner 10a (cyan for example) and the amount of white toner 30 is smaller as compared to region 3. At region 3, there are three color toners 10 (CMY) without any black toner 20 at a location of the toner image in which case the white toner 30 is used the most as compared to regions 1 and 2. It is still important to note that the amount of white toner 30 used is reduced as compared to the prior art. It is instructive to note at this point that that there are several preferred embodiments for the toners. First, the particle size of the black toner 20 and color toners 10 is preferably within a range of 4 to 12 microns, and the particle size of the white toner 30 is within a range of 4 to 50 microns. Secondly, the covering power of the black toner 20 is within a range of 400 to 4000 cm²/g, and the mass laydown of the black toner 20 is within a range of 0 to 0.9 mg/cm². Finally, the amount of white toner 30 is zero when the amount of a product of the mass laydown and covering power of the black toner 20 is greater than a threshold value, and the amount of white toner 30 is a function of the mass lay-down and the covering power of the black toner. In other words, an amount of white toner 30 in the fused image is zero in the region of the document where the laydown and covering power of the black toner 20 image is greater than a threshold value. A high density black toner is defined as the black toner 20 which has a covering power defined by the expression:

CP of Black Toner>130000/Dᵥₒₗ

where Dᵥₒₗ is the median volume average diameter of the black toner.

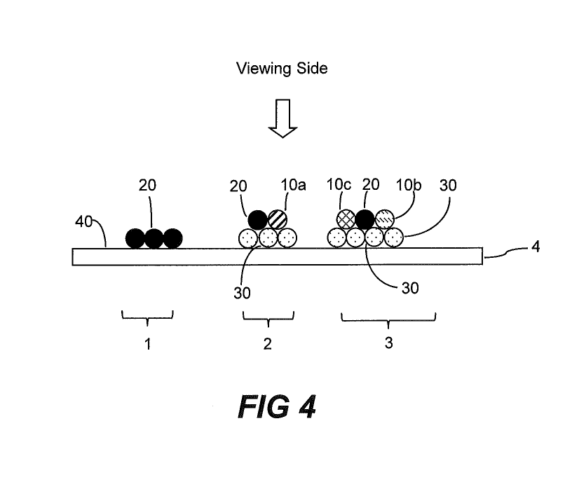

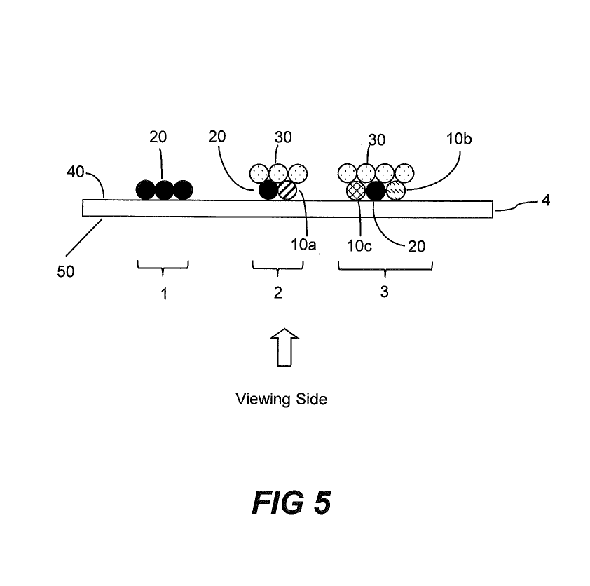

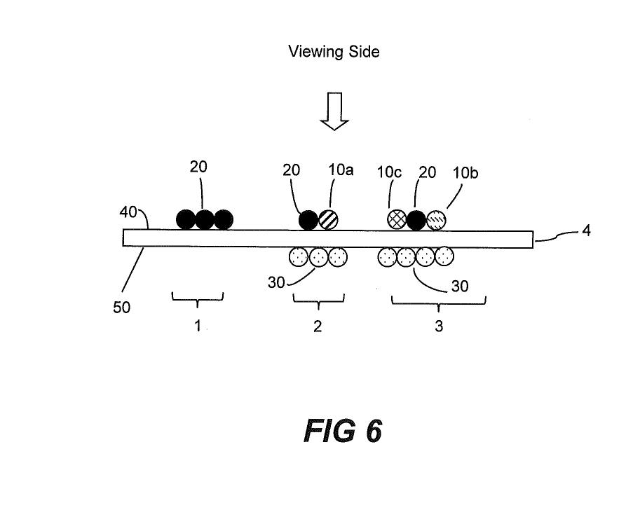

FIGS. 4-6 illustrate the different arrangements of the color toners 10, black toner 20 and white toner 30 for either of the embodiments of FIG. 2 (high density black) or FIG. 3 (low density black) deposited on either side or on both sides of the transparent substrate 4. Referring to FIG. 4, there are shown the color toners 10, black toner 20 and white toner 30 fixed or fused to a first side 40 of the transparent substrate 4 in which the first side 40 is the viewing side of the document (see the arrow). In the case where the white toner 30 exists (regions 2 and 3), the white toner 30 is adjacent the transparent substrate 4 or, in other words, the white toner 30 is farther away relative to the color toner 10 from the viewing side. Referring to FIG. 5, the color 10, black 20 and white toners 30 are fixed or fused to the first side 40 of the transparent substrate 4 in which a second side 50 (opposite the first side) is the viewing side of the document (see the arrow). In the case where the white toner 30 exists (regions 2 and 3), the color toners 10 and black toner 20 are adjacent the transparent substrate 4 or, in other words, the white toner 30 is farther away relative to the color toner 10 or black toner 30 from the viewing side. Referring to FIG. 6, the color toners 10 and black toner 20 are fixed or fused to a first side 40 and the white toner 30 is fixed or fused to the second side 50 in which the first side 40 is the viewing side of the document (as indicated by the arrow). In the case where white toner exists (regions 2 and 3), the location of the white toner 30 in the fused image is farther away relative to the color toner 10 from the viewing side.

In an embodiment of an electrophotographic modular printing machine useful with various embodiments (e.g., the NEXPRESS 2100 printer manufactured by Eastman Kodak Company of Rochester, N.Y.) color-toner print images are made in a plurality of color imaging modules arranged in tandem, and the print images are successively electrostatically transferred to a receiver adhered to a transport web moving through the modules. Colored toners include colorants, (e.g., dyes or pigments) which absorb specific wavelengths of visible light. Commercial machines of this type typically employ intermediate transfer members in the respective modules for transferring visible images from the photoreceptor and transferring print images to the receiver. In other electrophotographic printers, each visible image is directly transferred to a receiver to form the corresponding print image.

The invention has been described in detail with particular reference to certain preferred embodiments thereof, but it will be understood that variations and modifications can be effected within the spirit and scope of the invention.

### PARTS LIST

M1-M5 printing modules
1 region
2 region
3 region
4 transparent substrate
5 receiver material
10a color toner
10b color toner
10c color toner
10 a plurality of color toners
20 black toner
30 white toner
40 first side
50 second side
60 fuser assembly
62 fuser roller
64 fuser roller
98 low-density curve
99 curve
100 electrophotographic printing apparatus
101 endless transport web
102 rollers
103 rollers
111 photoconductive imaging roller
112 intermediate transfer roller
113 transfer backup roller
230 logic and control unit

1. A method for creating a document, the method comprising the steps of:
providing a transparent substrate;
providing a toner image, which is comprised of a plurality of color toners and a black toner;
determining an amount of white toner to be deposited dependent upon a mass laydown of the black toner and a covering power of the black toner;
depositing the determined amount of white toner with the color toners and black toner on the transparent substrate for reducing the amount of the white toner necessary for the toner image; and
fixing the deposited toners on the substrate.

2. The method according to claim 1, wherein the amount of white toner is determined using a look-up-table for the black toner.

3. The method according to claim 1, wherein a particle size of the black toner and color toners is within a range of 4 to 12 microns.

4. The method according to claim 1, wherein a particle size of the white toner is within a range of 4 to 50 microns.

5. The method according to claim 1, wherein the color, black and white toners are fixed using heat and pressure.

6. The method according to claim 5, wherein the heat and pressure are provided by a belt fusing device.

7. The method according to claim 1, wherein black toner is high density black toner and the covering power of the high density black toner meets the following criteria:
CP of Black Toner>13000/Dᵥₒₗ.

8. The method according to claim 1, wherein black toner is low density black toner and the covering power of the low density black toner meets the following criteria:
CP of Black Toner<13000/Dᵥₒₗ.

9. The method according to claim 1, wherein the covering power of the black toner is within a range of 400 to 4000 cm²/g.

10. The method according to claim 1, wherein the mass laydown of the black toner is within a range of 0 to 0.9 mg/cm².

11. (canceled)

12. (canceled)

13. The method according to claim 1, wherein the color, black and white toners are used in a mono-component or dual component development system.
